(19) United States
(12) Patent Application Publication
(10) Pub. No.: US 2025/0259089 A1
(43) Pub. Date: Aug. 14, 2025

(54) QUANTUM CONTROLLER FOR QUANTUM COMPUTING SYSTEM

(71) Applicant: Anyon Systems Inc., Dorval (CA)

(72) Inventor: Alireza Najafi-Yazdi, Vaudreuil-Dorion (CA)

(21) Appl. No.: 18/612,775

(22) Filed: Mar. 21, 2024

Related U.S. Application Data
(60) Provisional application No. 63/453,680, filed on Mar. 21, 2023.

(51) Int. Cl. G06N 10/40

(52) U.S. Cl. CPC G06N 10/40

(57) ABSTRACT

There is described a quantum controller for interfacing between a host computer and a quantum processing unit (QPU) having a plurality of qubits. The quantum controller comprises signal processing hardware configured for transforming instructions from the host computer into control signals readable by the QPU, the signal processing hardware comprising programmable logic and signal conversion circuits; hardware accelerator components dedicated to tasks offloaded from the programmable logic, the hardware accelerator components comprising at least one processor different from the QPU; and a carrying substrate on which the signal processing hardware and the hardware accelerator components are coupled, the carrying substrate providing power and signal routing to the signal processing hardware and the hardware accelerator components.

### CROSS-REFERENCE TO RELATED APPLICATIONS

The present application claims the benefit of U.S. Provisional Patent Application No. 63/453,680 filed on Mar. 21, 2023, the contents of which are hereby incorporated by reference in their entirety.

### TECHNICAL FIELD

The present disclosure generally relates to quantum computing and more particularly, to control system architectures for communicating with quantum processors.

### BACKGROUND OF THE ART

Quantum computers are machines that harness the properties of quantum states, such as superposition, interference, and entanglement, to perform computations. In a quantum computer, the basic unit of memory is a quantum bit, or qubit. A quantum computer with enough qubits has a computational power inaccessible to a classical computer, which is referred to as “quantum advantage”.

Qubits are hosted in quantum processors and are controlled through classical computers and control electronics. Operations performed on qubits, such as gating and readouts, involve microwave pulses, microwave pulse shaping, signal conversion, and signal processing. As the number of qubits in a QPU scales and the complexity of the computation increases, there is a need to provide improved capabilities for control electronics.

### SUMMARY

In accordance with a first broad aspect, there is provided a quantum controller for interfacing between a host computer and a quantum processing unit (QPU) having a plurality of qubits. The quantum controller comprises signal processing hardware configured for transforming instructions from the host computer into control signals readable by the QPU, the signal processing hardware comprising programmable logic and signal conversion circuits; hardware accelerator components dedicated to tasks offloaded from the programmable logic, the hardware accelerator components comprising at least one processor different from the QPU; and a carrying substrate on which the signal processing hardware and the hardware accelerator components are coupled, the carrying substrate providing power and signal routing to the signal processing hardware and the hardware accelerator components.

Features of the systems, devices, and methods described herein may be used in various combinations, in accordance with the embodiments described herein.

### BRIEF DESCRIPTION OF THE DRAWINGS

Reference is now made to the drawings, in which:

FIGS. 1A-1C are block diagrams of example embodiments of a quantum computing system;

FIG. 2 is a block diagram of an example embodiment of a quantum controller;

FIG. 3 is a block diagram of an example embodiment of signal processing hardware;

FIGS. 4A-4E are block diagrams of example embodiments of an intermediate frequency circuit;

FIG. 5 is a block diagram of an example embodiment of a radio frequency circuit;

FIG. 6 is a block diagram of another example embodiment of signal processing hardware;

FIG. 7 is a block diagram of an example embodiment of a combined circuit;

FIGS. 8A-8D are block diagrams of example embodiments of the quantum controller with a system-on-module architecture;

FIG. 9 is a block diagram of an example classical computing device; and

FIG. 10 is a block diagram of an example embodiment of a central memory bank.

### DETAILED DESCRIPTION

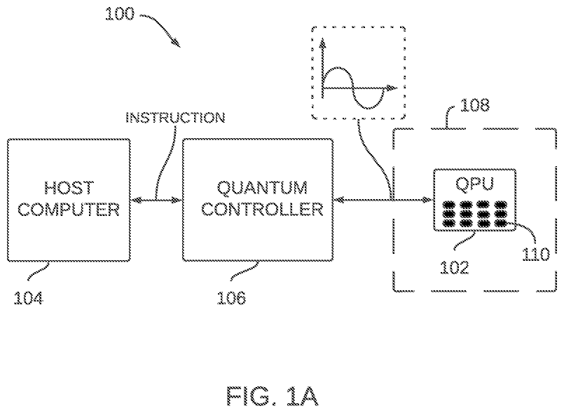

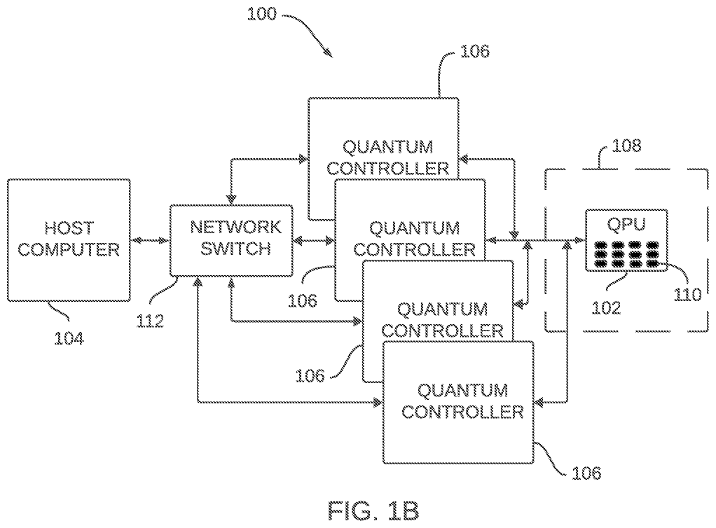

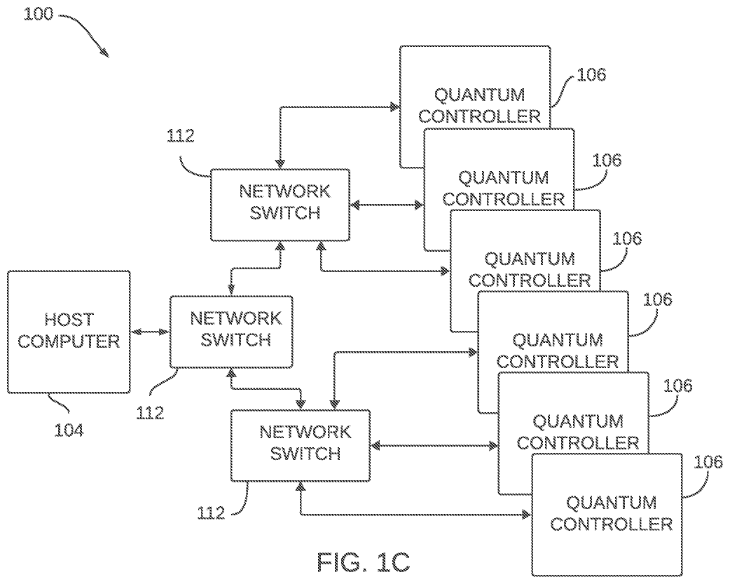

Referring to FIG. 1A, there is illustrated an example architecture of a quantum computing system 100. The system 100 includes a quantum processing unit (QPU) 102, a host computer 104, and a quantum controller 106 coupled therebetween. As used herein, a QPU is the brain of the quantum computing system 100 and uses the behavior of particles like electronics or photons to make certain kinds of calculations with greater efficiency than a central processing unit (CPU). The QPU 102 comprises a plurality of quantum bits (qubits) 110. Any number of qubits 110 may be provided in the QPU 102, from just a few qubits 110, to tens of qubits 110, to hundreds of qubits 110, to thousands of qubits 110, to millions of qubits 110. The qubits 110 may be based on various technologies, such as but not limited to solid state, trapped ions, neutral atoms, photonic, and others. The solid state qubits may be superconducting qubits, semiconductor spin qubits, topological qubits, artificial atoms in solids, and quantum dots. The capability and efficiency of the QPU 102 is influenced by the number of qubits available as well as by coherence times, connectivity, gate speeds, error rates, and other factures. The QPU 102 may be packaged similarly to a CPU or a graphics processing unit (GPU), as a chip or a module with multiple chips.

The operating environment 108 of the QPU 102 may be cryogenic, room-temperature, or a combination thereof. In some embodiments, the operating environment 108 is a dilution refrigerator. Dilution refrigerators are cryogenic devices that provide continuous cooling in a cryostat from ambient temperature all the way down to millikelvin temperatures without any moving part at the low temperature stages (below 3 K). The cryostat consists of one or more vacuum enclosure with cold flanges that progressively reach low temperatures for the operation of the QPU 102. In some embodiments, the operating environment 108 includes a high-vacuum enclosure.

The quantum controller 106 consists of dedicated hardware for controlling and operating the qubits 110 in the QPU 102. Although illustrated as separate from the operating environment 108, one or more component of the quantum controller 106 may reside inside a cryogenic environment, such as inside a cryostat, which may form part of the operating environment 108 of the QPU 102 or be separate therefrom. The one or more component of the quantum controller 106 inside the cryogenic environment may be held at the same temperature as the QPU 102 (and in some cases form part of the QPU 102 itself) or at a higher temperature, as appropriate. In some embodiments, one ore more component of the quantum controller 106 is held at the same temperature as the QPU 102 and one or more component of the quantum controller 106 is held at a higher temperature than the QPU 102 inside the cryogenic environment. In some embodiments, a first subset of the quantum controller 106 is held at the same temperature as the QPU 102 (i.e. cryogenic temperatures), a second subset of the quantum controller 106 is held at a higher temperature than the QPU inside a cryostat, and a third subset of the quantum controller 106 is held at room temperature outside of the cryostat. Other embodiments may also apply.

The quantum controller 106 is coupled to one or more host computer 104, which acts as the interface between the outside world and the quantum computing system 100. Although a single host computer 104 is illustrated, it will be understood that there may a plurality of host computers 104 connected to the quantum controller 106. The host computer 104 may be a classical computer, used to access the QPU 102 and more specifically, to create and run quantum algorithms on the QPU 102. The quantum controller 106 receives instructions from the host computer 104 and converts the instructions into waveforms that are readable by the QPU 102. The instructions may relate to various types of operations performed on the QPU 102, such as but not limited to gating operations, calibration operations, tuning operations, and measurement operations.

One of the challenges associated with quantum control is the short lifetime of qubits, also known as qubit coherence time (or decoherence). Coherence time is a measurement of how long a qubit can maintain its complex quantum state. Depending on the qubit technology, coherence times may be anywhere from nanoseconds to seconds. This means that the time taken to perform a quantum algorithm on the QPU 102 must be less than the coherence time of the qubits on which the quantum algorithm is performed. This imposes strict constraints on latency times for end to end communications between the host 104, the quantum controller 106 and the QPU 102. These constraints are increased as the number of qubits in the QPU 102 increases and the algorithms involve many quantum gates applied to many qubits. Performing error correction further adds latency restrictions, as this makes the communications between the host 104, quantum controller 106, and QPU 102 bi-directional. In many error correction schemes, one or more quantum gates are applied to the qubits in the QPU 102, a readout is taken of the QPU 102 as part of error detection (also called syndrome measurement), and then a recovery or correction operation is performed on the QPU 102 based on the detected error. In some cases, the latency for end to end communications needs to be as low as a few nanoseconds in order to allow error correction schemes to be performed. As the demands on computation increase and various types of processors (i.e. QPU, CPU, GPU) are used together, latency in communication between such processors is expected to become a critical issue.

There is described herein an architecture for a quantum controller that reduces the latency times for large scale quantum computing. The architecture is scalable to allow the number of qubits 110 in the QPU 102 to increase without performance degradation. The architecture is also modular, providing flexibility for various qubit technologies and designs.

FIG. 1B illustrates an example embodiment of a quantum computing system 100 for a QPU 102 having a large number of qubits 110. In this example, a plurality of quantum controllers communicate with the QPU 102, whereby each quantum controller 106 may be dedicated to a subset of qubits 110 in the QPU 102. For example, the QPU 102 may comprise 80 qubits, and each quantum controller 106 may communicate with 20 of the 80 qubits. These numbers are only exemplary, and it will be understood that more or less qubits 110 may form part of the QPU 102 and each quantum controller 106 may communicate with more or less qubits 110 of the QPU 102.

One or more network switch 112 sits between the one or more host computer 104 and the plurality of quantum controllers 106 to direct the instructions from the host computer 104 to the suitable quantum controller 106 and to direct the data from the quantum controllers 106 to the host computer 104. In some embodiments, the network switch 112 comprises a plurality of network switches 112 that are cascaded and interconnected. An example is shown in FIG. 1C, where each network switch 112 may switch between three quantum controllers 106, and each pair of network switches 112 requires another network switch 112 to interface the network switches 112 coupled to the quantum controllers 106 and the host computer 104. If there were, for example, sixteen quantum controllers 106 and one network switch 112 for every four quantum controllers 106, there would be three layers of switches: a first layer of four switches 112, a second layer of two switches 112, and a third layer of one switch 112. It will be understood that the number of quantum controllers 106 depends on the number of qubits 110 in the QPU 102 and on the architecture of each quantum controller 106 to determine how many qubits 110 may be controlled per quantum controller 106. The number of network switches 112 depends on the number of quantum controllers 106 and the architecture of each network switch 112 to determine how many quantum controllers 106 one network switch 112 can communicate with.

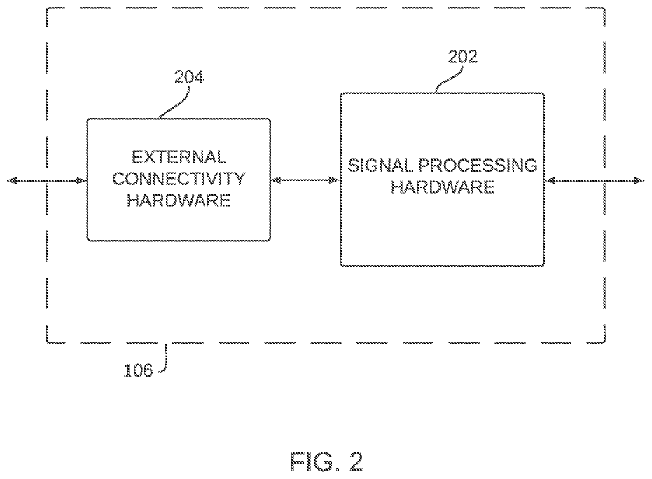

Referring to FIG. 2, there is shown an example embodiment of the quantum controller 106. In this example, the quantum controller 106 comprises external connectivity hardware 204 and signal processing hardware 202. The external connectivity hardware 204 couples the signal processing hardware 202 to the host computer 104 to allow transmission of the instructions from the host computer 104 to the quantum controller 106. In some embodiments, the host computer 104 and quantum controller 106 communicate using Ethernet. The external connectivity hardware 204 may comprise peripheral interconnects which include bus interface circuits for Peripheral Component Interconnect (PCI), PCI express (PCIe), PCI extended (PCIx), universal serial bus (USB), universal asynchronous transceiver (UART), serial advanced technology attachment (SATA) and Ethernet. The bus interface circuits may include one or more slot, port, wire, bus, bridge, card, connector, and the like. In addition, or alternatively, the host computer 104 and quantum controller 106 communicate using InfiniBand. The external connectivity hardware 204 may comprise physical interconnection components such as cables (active, passive, or optical fiber), connectors, switches, routers, adapters, network cards, and any other hardware component used for InfiniBand-based communications. It will be understood that various combinations of external connectivity hardware 204 may be used, such as InfiniBand, Ethernet, OmniPath, Cray, and the like. Any other hardware component needed to allow communication between the quantum controller 106 and the host computer 104 may be provided as part of the external connectivity hardware 204.

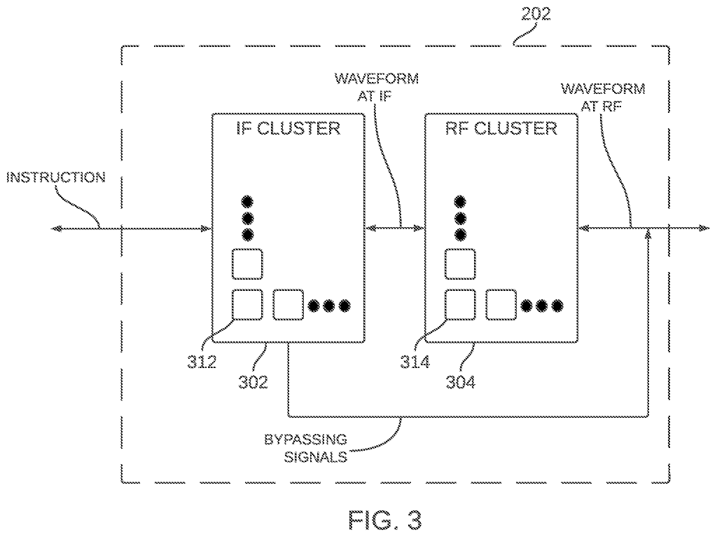

The signal processing hardware 202 transforms the instructions from the host computer 104 into signals readable by the QPU 102. An example embodiment of the signal processing hardware 202 is illustrated in FIG. 3. An Intermediate Frequency (IF) cluster 302 comprises a plurality of IF circuits 312. The number of IF circuits 312 needed for operation of the quantum computing system 100 depends on the number of qubits 110 present in the QPU 102. The IF cluster 302 receives, through the external connectivity hardware 204, the instructions from the host computer 104 and generates therefrom an analog waveform at a first low frequency, referred to herein as an intermediate frequency, for example in a frequency range of 0 to 2 GHz. A Radio Frequency (RF) cluster 304 is coupled to the IF cluster 302 and comprises a plurality of RF circuits 314. The analog waveform at the IF frequency is received by the RF cluster 304 and up-converted to a second higher frequency, such as 4 to 15 GHZ, for delivery to the QPU 102. Measurements made on the QPU 102 are received at the RF cluster 304 as a waveform at the higher frequency and down-converted to the lower frequency range. The lower frequency waveform is transmitted from the RF cluster 304 to the IF cluster 302 for conversion back into an instruction format, for transmission to the host computer 104. Signals that do not need to be upconverted, for example flux-tuning signals, may bypass the RF cluster 304 and go directly from the IF cluster 302 to the QPU 102.

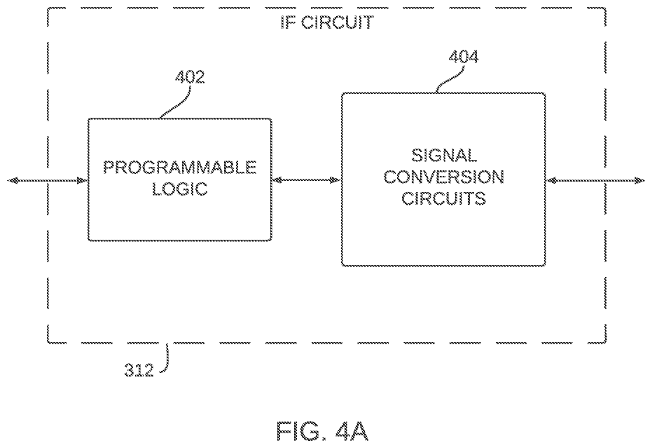

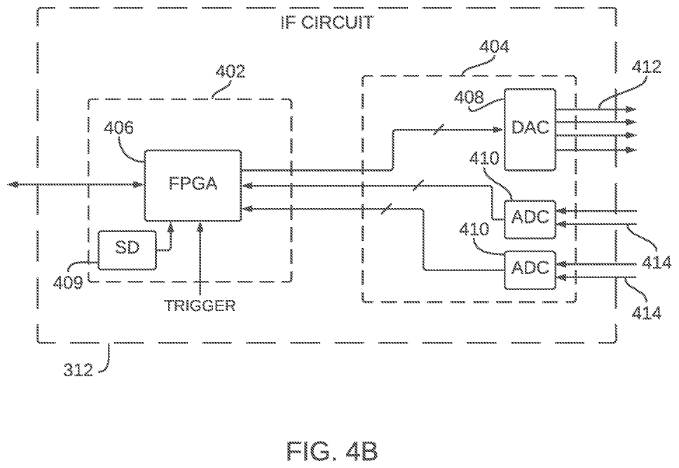

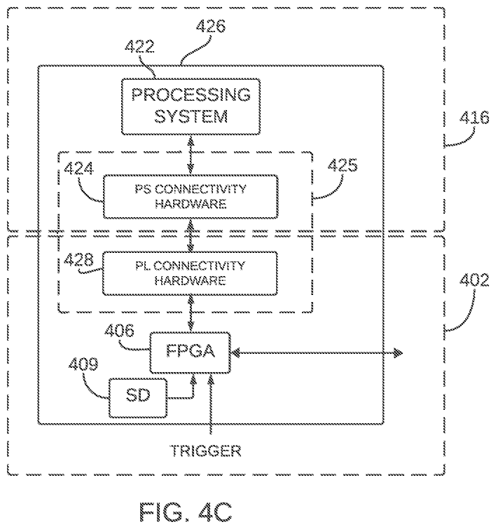

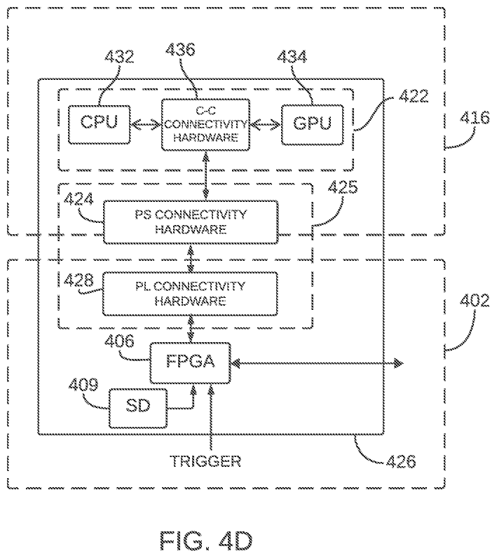

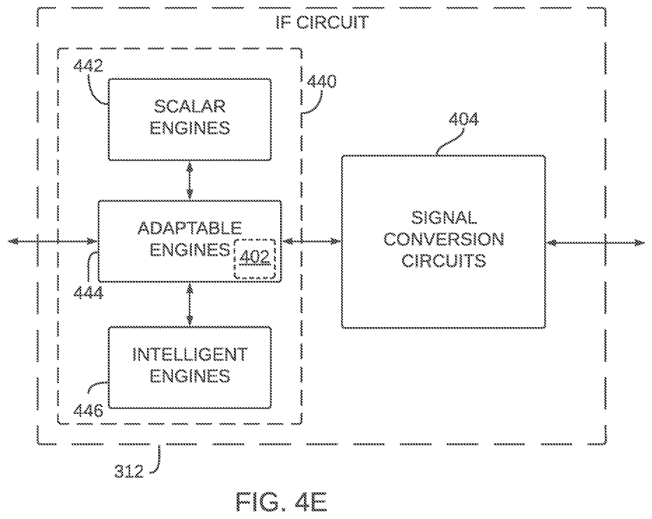

The IF circuits 312 may be implemented using various embodiments. With reference to FIG. 4A, programmable logic 402 is coupled to signal conversion circuits 404. The programmable logic 402 comprises one or more circuit that can be configured to implement logic functions using logic elements and a hierarchy of interconnects that may or may not be reconfigurable. For example, the programmable logic may comprise one or more Programmable Logic Device (PLD), such as Programmable Read Only Memory (PROM), Programmable Array Logic (PAL), and Programmable Logic Array (PLA). In some embodiments, the programmable logic 402 comprises one or more Application-Specific Integrated Circuit (ASIC). In some embodiments, the programmable logic 402 comprises one or more Complex Programmable Logic Device (CPLD). In some embodiments, the programmable logic 402 comprises one or more Field Programmable Gate Array (FPGA). The signal conversion circuits 404 are configured for performing digital to analog conversions using one or more digital-to-analog converter (DAC), and analog to digital conversions using one or more analog-to-digital converter (ADC).

FIG. 4B illustrates a detailed example of the IF circuit 312 shown in FIG. 4A. The programmable logic 402 comprises an FPGA 406 and a storage device (SD) 409. The signal conversion circuits 404 comprise one or a plurality of DAC 408 and/or ADCs 410. The FPGA 406 receives an instruction and may access the SD 409 to retrieve a pre-determined waveform associated with the instruction or generate a waveform based on the received instruction. This waveform is then delivered to DAC 408 for conversion from digital to analog form at a gigabit/second rate using serial low voltage differential signaling (LVDS). Alternatively, a higher speed interface is used between the FPGA 406 and the DAC 408 to reduce the number of data output lanes needed, such as JESD204, JESD204A, JESD204B, JESD204C. In this case, the FPGA 406 outputs the waveform on fewer lanes at higher speed.

In some embodiments, the FPGA 406, the SD 409 and the signal conversion circuits 404 may be provided on a same substrate and/or chip, which may also have other components for hardware acceleration. An example is shown in FIG. 4C. The programmable logic 402 comprises the FPGA 406 and SD 409 on a substrate 426 which may be, for example, a printed circuit board (PCB). In this example, hardware accelerator components 416 are coupled to the programmable logic 402. Some or all of the hardware accelerator components 416 may be provided on the substrate 426 with the programmable logic 402, for example as part of a system-on-chip (SoC) or a system-on-module (SOM). The hardware accelerator components 416 comprise a processing system 422 that is separate from any other processor running on the host computer 104 and is dedicated to certain tasks that may be offloaded from the FPGA 406. In some embodiments, the processing system 422 comprises one or more single or multi-core processors.

The programmable logic 402 and hardware accelerator components 416 may communicate through internal connectivity hardware 425. In some embodiments, Programmable Logic (PL) connectivity hardware 428 and Processing System (PS) connectivity hardware 424 are provided separately. This may be the case if, for example, the programmable logic 402 and the hardware accelerator components 416 are provided on separate chips and/or separate SoMs. Alternatively, a single set of internal connectivity hardware 425 may be provided between the processing system 422 and the FPGA 406 on the substrate 426. The internal connectivity hardware 425 may be suitable for general connectivity (e.g. GigE, USB 2.0, CAN, UART, SPI, Quad SPI NOR, NAND, SD/eMMC) or high-speed connectivity (e.g. USB 3.0, SATA 3.1, PCIe, PS-GTR).

In some embodiments, and as shown in FIG. 4D, the processing system 422 may comprise full central processing unit (CPU) 432 capabilities as well as full graphical processing unit (GPU) 434 capabilities, with chip-to-chip (C-C) connectivity hardware 436 provided therebetween. In this case, both the CPU 432 and the GPU 434 act as hardware accelerators in the quantum controller 106. The C-C connectivity hardware 436 may be suitable for PCI, PCIe, or PCIx communication. Alternatively or in combination therewith, the C-C connectivity hardware 436 may be a wire-based serial multi-lane near-range communication link or other similar high-speed interconnect technology. It will be understood that the requirements for high-speed interconnection in the quantum controller 106 are very high and that any technology that allows high-speed low latency communication between the various components may be used.

In some embodiments, and as shown in FIG. 4E, the programmable logic 402 forms part of an Adaptive Compute Acceleration Platform (ACAP) 440, which is a fully software-programmable, heterogeneous compute platform that combines adaptable engines 444 with scalar engines 442 and intelligent engines 446. The scalar engines 442 are, for example, CPUs or other types of processors that provide efficient complex algorithm computation using scalar and sequential processing. The scalar engines 442 are programmable at the software level. The adaptable engines 444 are adaptable hardware that include the programmable logic 402 and memory cells (e.g. storage device 409) and provide flexible parallel computing with fast local memory and custom input/output. The adaptable engines 444 are programmable at the hardware level. The intelligent engines 446, such as digital signal processing (DSP), GPU, Artificial Intelligence (AI) engines, and the like, are vector processing elements that are efficient at a narrow set of parallelizable compute functions. They are particularly well suited for machine learning and digital signal processing applications. The intelligent engines 446 are programmable at the software level. Various embodiments for the ACAP 440 may be used to provide the desired functionalities of the quantum controller 106.

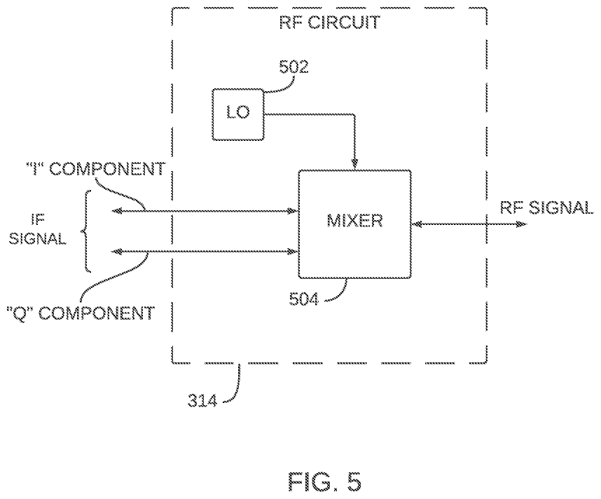

Referring to FIG. 5, there is shown an example embodiment of an RF circuit 314 from the RF cluster 304. When upconverting a signal, the RF circuit 314 takes as input the IF signal output by the IF circuit 312 in two components, namely the in-phase (I) component and the in-quadrature (Q) component. The IF signal is received at a frequency mixer 504 and multiplied with a signal from a local oscillator (LO) 502 in order to output an upconverted signal, i.e. the RF signal. When down-converting a signal, the RF circuit 314 takes as input the RF signal received from the QPU 102 and multiplies the RF signal with a signal from the LO 502 in order to obtain the IF signal. The IF signal is sent to the IF circuit 312 as the I and Q components. Other embodiments for upconverting/down-converting between the IF signal and the RF signal are also contemplated.

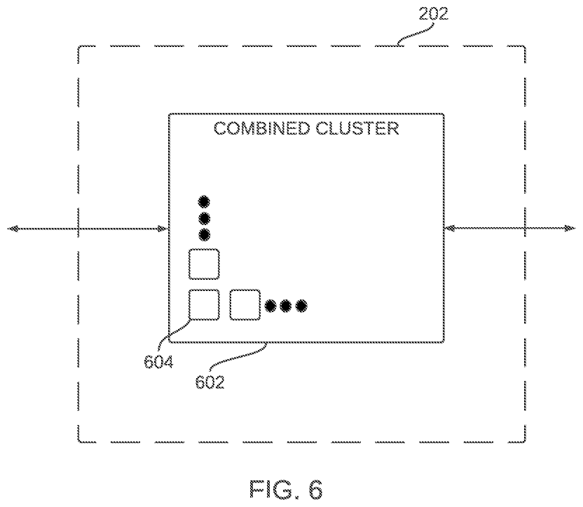

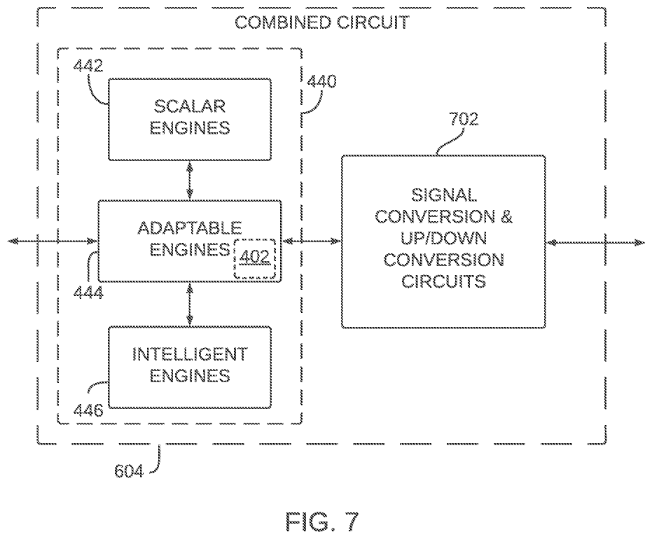

In some embodiments, there is no need for separate IF and RF clusters 302, 304 in the signal processing hardware 202. Instead, a fully integrated RF SoC that can directly synthesize complex signals up to the required radio frequency on-chip may be used. As shown in the example of FIG. 6, the signal processing hardware 202 may comprise a combined cluster 602 of signal processing circuits 604. Each signal processing circuit 604 may comprise all of the hardware needed to receive an instruction from the host computer 104 and generate an RF waveform for delivery to the QPU 102. An example embodiment is shown in FIG. 7, where the combined circuit 604 comprises at least the programmable logic 402 and in some cases an ACAP 440 with scalar engines 442, adaptable engines 444, and intelligent engines 446. In addition, signal conversion & up/down conversion circuits 702 are provided to perform signal conversion (i.e. from analog to digital and from digital to analog) and up/down conversion (i.e. up-convert to RF and down-convert to IF). This may be done, for example, using ADC and DAC RF converters that are integrated on-chip and/or on-module with the programmable logic 402. The DAC/ADC RF converters may be designed to directly measure and synthesize microwave signals at the desired frequency range.

In some embodiments, the signal processing hardware 202 comprises three (3) DAC channels per qubit in order to be able to do flux-tuning of qubits. Using 4-channel DACs, a QPU 102 having fifty-two (52) qubits 110 would require one hundred fifty-six (156) DAC channels and therefore thirty-nine (39) DACs. If one 4-channel DAC is provided per IF circuit 312 or per combined circuit 604, then thirty-nine (39) IF circuits 312 or combined circuits 604 are provided per IF cluster 302 or combined cluster 602. Alternatively, if no flux-tuning is required, the signal processing hardware 202 comprises two (2) DAC channels per qubit. Using the same example as above based on 4-channel DACs, a QPU 102 having fifty-two (52) qubits 110 would require one hundred four (104) DAC channels and therefore twenty-six (26) DACs. If one 4-channel DAC is provided per IF circuit 312 or per combined circuit 604, then twenty-six (26) IF circuits 312 or combined circuits 604 are provided per IF cluster 302 or combined cluster 602. It will be understood that the number of IF circuits 312 or combined circuits 604 may vary depending on the number of channels per DAC and the number of DACs per IF circuits 312 or combined circuits 604.

The number of ADC per qubit depends on the qubit readout architecture in the QPU 102. Two ADC channels are needed per readout resonator. If the architecture provides one readout resonator per qubit, then one 2-channel ADC is needed per qubit. If the architecture provides one readout resonator per n qubits, then one 2-channel ADC is needed per n qubits. Therefore, the total number of ADCs forming part of the signal processing hardware 202 may differ from the total number of DACs forming part of the signal processing hardware 202.

In some embodiments, each quantum controller 106 is implemented as one carrying substrate having attached thereto a plurality of system-on-modules (SOM). A SOM (also known as computer-on-module (COM) provides the core components of an embedded processing system, including processor cores, communication interfaces, and memory blocks, on a single physical unit, which can be a production-ready printed circuit board (PCB) or another substrate. The single physical unit reduces the complexity of design of the quantum controller 106 and makes it modular and scalable. An increase in qubits 110 in the QPU 102 can be accommodated by adding a SOM for additional signal processing hardware 202. New functionalities can be accommodated by adding a SOM for additional hardware accelerator components 416. The same architecture for the quantum controller 106 may be used for a qubit design that requires many RF lines (for example for gating and readout) and for a different qubit design that requires few RF lines (for example only for readout) by providing more or less SoMs on the carrying substrate.

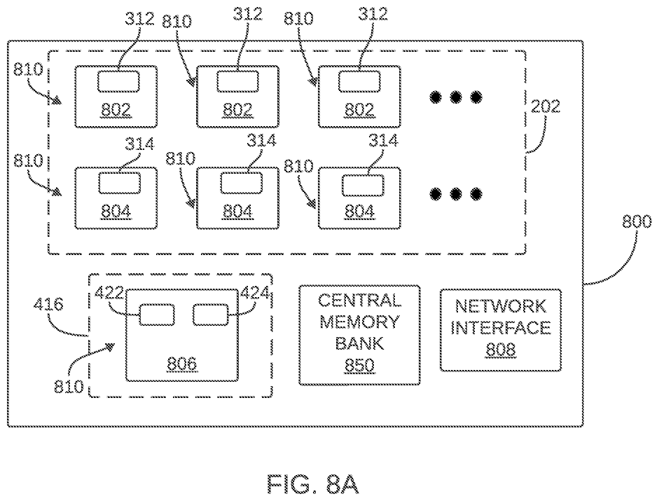

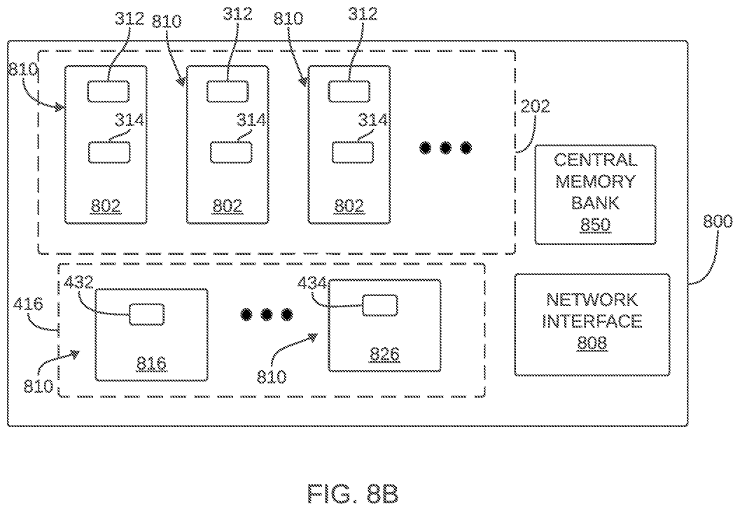

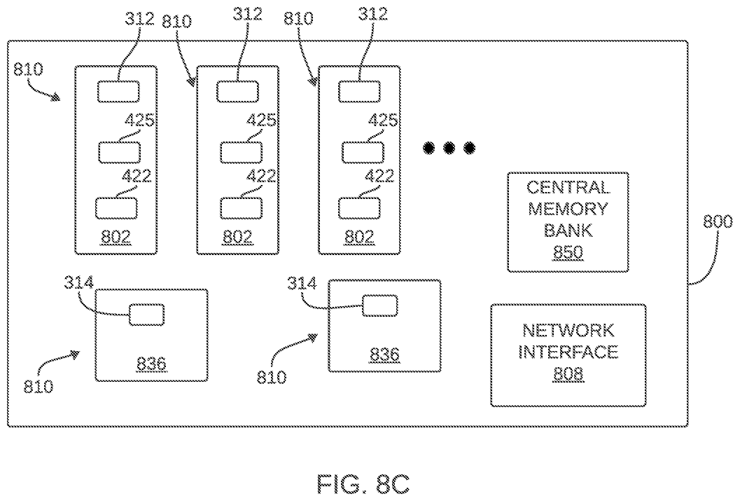

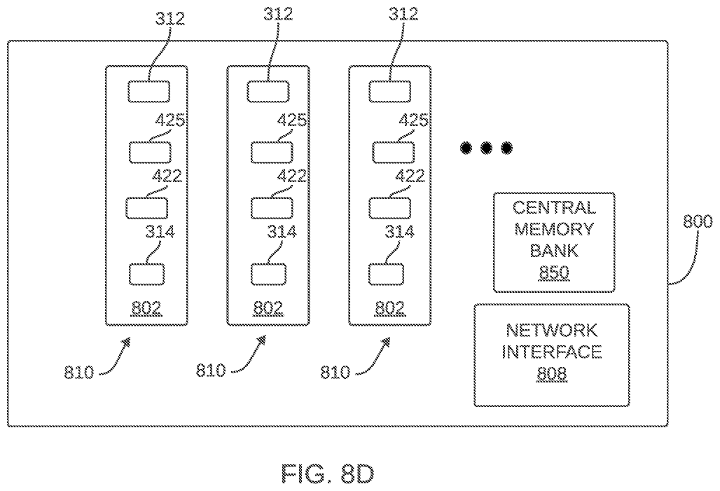

The SoMs may be arranged in accordance with various embodiments. Referring to FIG. 8A, there is illustrated an embodiment for the quantum controller 106. A carrying substrate 800 provides power and signal routing (e.g. through traces) to all components attached thereto. In this example, the signal processing hardware 202 is provided across two sets of SoMs 810. Each IF circuit 312 is mounted to a substrate 802 and together form a SOM 810, and each RF circuit 314 is mounted to a substrate 804 and form a SOM 810. The substrates 802, 804 may be mounted to the carrying substrate 800 using, for example, a mezzanine connector which may be low pin count (LPC) or high pin count (HPC). Other types of connectors may also be used. The hardware accelerator components 416 are provided as a single SOM 810. For example, the processing system 422 and processing system connectivity hardware 424 are mounted to a substrate 806 that is attached to the carrying substrate 800 using, for example, an FMC connector or another type of connector. The processing system 422 may comprise a CPU 432 and/or a GPU, and/or another FPGA, as well as any chip-to-chip connectivity hardware 436.

A network interface 808 is used for the quantum controller 106 to communicate with the with the host 104, other quantum controllers 106 and/or with a network switch 112. In some embodiments, a Central Memory Bank 850 (CMB) is provided on the carrying substrate 800 to further minimize latency in communications. The CMB 850 acts as a main memory for the quantum processor 106. Every component on the carrying substrate 800, whether a chip or a SOM, may be configured to read and write to the CMB 850, such that communications that come in through the network interface 808 need to access only the CMB 850 to retrieve information.

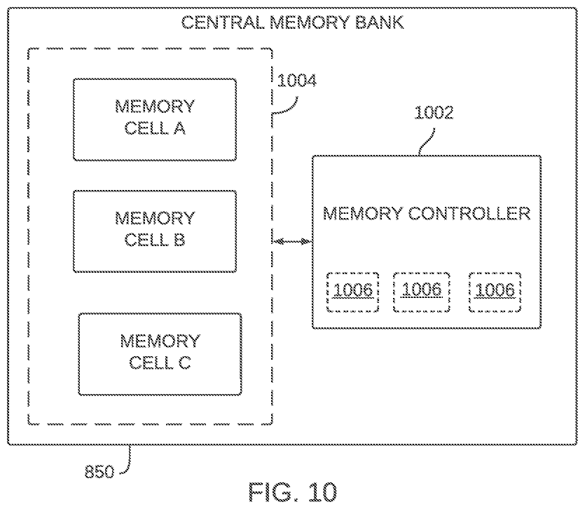

An example embodiment of the CMB 850 is shown in FIG. 10. It may comprise a memory controller 1002 and a single or a combination of memory cells 1004, such as but not limited to random access memory (RAM), dynamic random access memory (DRAM), static random access memory (SRAM), High Bandwidth Memory (HBM), cache memory, and the like. The memory controller 1002 may itself have internal memory storages units 1006, for example for caching. The memory controller 1002 is responsible to manage simultaneous read and write operations by SoMs 810, and the network interface 808 to the memory cells 1004. Allowing for simultaneous read and write operations by SoMs 810 and the network interface 808 allows for bypassing the sending of requests to processing units, such as CPU, GPU, FPGA, and the like, and hence significantly reduces latency.

In one example implementation, the CMB 850 may itself be implemented as a system-on-module. In another example implementation, the CMB 850 and the network interface 808 may be implemented within the same device such as an FPGA or an ASIC.

Referring to FIG. 8B, there is illustrated another embodiment for the quantum controller 106. In this example, the IF circuit 312 and RF circuit 314 are provided together on a SOM 810 that is duplicated multiple times. Also in this example, the hardware accelerator components 416 are provided across two SoMs 810. A CPU 432 is provided on a substrate 816 and a GPU 434 is provided on a substrate 826. This embodiment adds flexibility to the processing capabilities provided on the quantum controller 106 as any number of CPU and GPU may be added modularly. A second CPU 432 may be added to the same substrate 816 as part of the SOM 810 or on another substrate 816 as a separate SOM 810. A second GPU 434 may be added to the same substrate 826 as part of the SOM 810 or on another substrate 826 as a separate SOM 810.

Referring to FIG. 8C, there is illustrated yet another embodiment for the quantum controller 106. In this example, some of the signal processing hardware 202 is combined with some of the hardware accelerator components 416 to form SoMs 810, and the rest of the signal processing hardware 202 is provided on separate SoMs 810. For example, the IF circuit 312, processing system 422, and internal connectivity hardware 425 are provided together on a substrate 802 to form a SOM 810, which is duplicated across the carrying substrate 800. The RF circuit 314 is provided on another substrate 836 to form a SOM 810, which may also be duplicated across the carrying substrate 800. This embodiments provides flexibility for qubit architectures that requires less RF circuits 314 than IF circuits 312, and can further reduce latency communications between the processing system 422 and the IF circuit 312 by having them on a same SOM 810. Furthermore, standard SoMs incorporating FPGA and GPU capabilities, FPGA and CPU capabilities, or FPGA, CPU, and GPU capabilities can be added and removed in a plug-and-play manner from the carrying substrate 800.

Referring to FIG. 8D, there is illustrated yet another embodiment of the quantum controller 105. In this example, each SOM 810 is identical and includes an IF circuit 312, an RF circuit 314, a processing system 425 and internal connectivity hardware 422 mounted to a substrate 802. There can be more or less than three SoMs 810 attached to a carrying substrate 800, depending on the desired capabilities of the quantum controller 106 and the QPU 102 requirements, such as number of qubits, readout lines, qubit architecture, qubit technology, and the like.

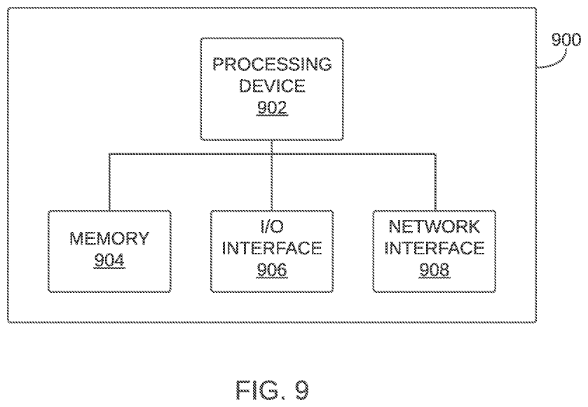

FIG. 9 is an example computing device 900 for implementing the host computer 104 in accordance with various embodiments. The host computer 104 can be used directly or through a network access by a user for creating and running quantum algorithms on the QPU 102. As depicted, the computing device 900 includes at least one processor 902, memory 904, at least one I/O interface 906, and at least one network interface 908. Processor 902 may be an Intel or AMD x86 or x64, PowerPC, ARM processor, or the like. Memory 904 may include a suitable combination of computer memory that is located either internally or externally such as, for example, random-access memory (RAM), read-only memory (ROM), integrated memory, compact disc read-only memory (CDROM).

Each I/O interface 906 enables the computing device 900 to interconnect with one or more input devices, such as a keyboard, mouse, camera, touch screen and a microphone, or with one or more output devices such as a display screen and a speaker. This interface can be used, for example, for receiving commands from a user intended for the quantum computing system 100.

Each network interface 908 enables the computing device 900 to communicate with other components, for example, through an API to exchange data with other components, to access and connect to network resources, to serve applications, and perform other computing applications by connecting to a network (or multiple networks) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g., Wi-Fi, WiMAX), SS7 signaling network, fixed line, local area network, wide area network, and others.

The described embodiments and examples are illustrative and non-limiting. Practical implementation of the features may incorporate a combination of some or all of the aspects, and features described herein should not be taken as indications of future or existing product plans. Applicant partakes in both foundational and applied research, and in some cases, the features described are developed on an exploratory basis.

The term “connected” or “coupled to” may include both direct coupling (in which two elements that are coupled to each other contact each other) and indirect coupling (in which at least one additional element is located between the two elements).

Although the embodiments have been described in detail, it should be understood that various changes, substitutions and alterations can be made herein without departing from the scope. Moreover, the scope of the present application is not intended to be limited to the particular embodiments of the process, machine, manufacture, composition of matter, means, methods and steps described in the specification.

As one of ordinary skill in the art will readily appreciate from the disclosure, processes, machines, manufacture, compositions of matter, means, methods, or steps, presently existing or later to be developed, that perform substantially the same function or achieve substantially the same result as the corresponding embodiments described herein may be utilized. Accordingly, the appended claims are intended to include within their scope such processes, machines, manufacture, compositions of matter, means, methods, or steps.

As can be understood, the examples described above and illustrated are intended to be exemplary only.

1. A quantum controller for interfacing between a host computer and a quantum processing unit (QPU) having a plurality of qubits, the quantum controller comprising:
signal processing hardware configured for transforming instructions from the host computer into control signals readable by the QPU, the signal processing hardware comprising programmable logic and signal conversion circuits;
hardware accelerator components dedicated to tasks offloaded from the programmable logic, the hardware accelerator components comprising at least one processor different from the QPU; and
a carrying substrate on which the signal processing hardware and the hardware accelerator components are coupled, the carrying substrate providing power and signal routing to the signal processing hardware and the hardware accelerator components.

2. The quantum controller of claim 1, wherein the signal processing hardware and the hardware accelerator components exchange data directly from a main memory coupled to the carrying substrate.

3. The quantum controller of claim 1, wherein the main memory comprises a memory controller and one or more memory cells, and the memory controller manages read and write operations by the programmable logic and the at least one processor to the one or more memory cells.

4. The quantum controller of claim 3, wherein the main memory is provided as a system-on-module on a substrate separate from the carrying substrate and mounted thereto.

5. The quantum controller of claim 3, wherein the main memory is implemented as a field programmable gate array (FPGA) or an application specific integrated circuit (ASIC), and the FPGA or ASIC also comprises a network interface.

6. The quantum controller of claim 1, wherein the signal processing hardware comprises an intermediate frequency (IF) circuit and a radio frequency (RF) circuit, the IF circuit converting the instructions received from the host computer into a waveform at a first frequency, the RF circuit upconverting the waveform at the first frequency to a second frequency higher than the first frequency.

7. The quantum controller of claim 1, wherein the programmable logic comprises a Field Programmable Gate Array (FPGA), and the signal conversion circuits comprise at least one digital to analog converter (DAC) and at least one analog to digital converter (ADC).

8. The quantum controller of claim 1, wherein the at least one processor of the hardware accelerator components comprise a central processing unit (CPU) and a graphics processing unit (GPU).

9. The quantum controller of claim 8, wherein the GPU and the CPU are provided together as at least one system-on-module on a substrate separate from the carrying substrate and mounted thereto.

10. The quantum controller of claim 8, wherein the GPU and the CPU are each provided as a separate system-on-module on substrates separate from the carrying substrate and mounted thereto.

11. The quantum controller of claim 1, wherein the signal processing hardware is provided as at least one system-on-module on a substrate separate from the carrying substrate and mounted thereto.

12. The quantum controller of claim 6, wherein the IF circuit is provided as at least one system-on-module on a substrate separate from the carrying substrate and mounted thereto.

13. The quantum controller of claim 12, wherein the at least one system-on-module with the IF circuit further comprises the at least one processor of the hardware accelerator components.

14. The quantum controller of claim 13, wherein the at least one processor comprises at least one of a central processing unit (CPU) and a graphics processing unit (GPU).

15. The quantum controller of claim 6, wherein the RF circuit is provided as at least one system-on-module on a substrate separate from the carrying substrate and mounted thereto.

16. The quantum controller of claim 6, wherein the IF circuit and RF circuit are together provided as at least one system-on-module on a substrate separate from the carrying substrate and mounted thereto.

17. The quantum controller of claim 1, wherein the hardware accelerator components are provided as at least one system-on-module on a substrate separate from the carrying substrate and mounted thereto.

18. The quantum controller of claim 1, wherein the signal processing hardware and the hardware accelerator components are provided as at least one system-on-module on a substrate separate from the carrying substrate and mounted thereto.

19. The quantum controller of claim 1, wherein the signal processing hardware comprises an adaptive compute acceleration platform (ACAP) having at least one scalar engine, at least one adaptable engine, and at least one intelligent engine.

20. The quantum controller of claim 1, wherein the programmable logic is integrated with digital to analog radio frequency (DAC RF) converters and analog to digital radio frequency (ADC RF) converters.
